(19) United States
(12) Patent Application Publication
(10) Pub. No.: US 2025/0109236 A1
(43) Pub. Date: Apr. 3, 2025

(54) THERMALLY CONDUCTIVE POLYURETHANE FOAMS, METHODS OF MAKING THE SAME, AND ARTICLES COMPRISING THE SAME

(71) Applicant: MOMENTIVE PERFORMANCE MATERIALS INC., Niskayuna, NY (US)

(72) Inventors: Mario Echeverri, Marietta, OH (US); Gabriel Kiss, Bergisch Gladbach (DE)

(21) Appl. No.: 18/897,080

(22) Filed: Sep. 26, 2024

Related U.S. Application Data
(60) Provisional application No. 63/541,311, filed on Sep. 29, 2023.

(51) Int. Cl. C08G 18/08; C08G 18/10; C08G 101/00; C08J 9/00; C08K 3/04; C08K 7/06

(52) U.S. Cl. CPC C08G 18/14; C08G 18/10; C08J 9/0066; C08K 3/04; C08K 7/06; C08G 2101/00; C08G 2110/0008; C08G 2110/005; C08G 2110/0058; C08J 2205/06; C08J 2375/04; C08K 2201/001; C08K 2201/004; C08K 2201/016

(57) ABSTRACT

A polyurethane foam, a polyurethane foam-forming composition, and method of making the same comprising a thermally conductive filler. The thermally conductive filler is selected from carbon rich carbon fibers. The foams exhibit excellent thermal conductivity across a wide range foam densities.

### CROSS-REFERENCE TO RELATED APPLICATIONS

The present application claims priority to and the benefit of U.S. Provisional Application No. 63/541,311 titled “Thermally Conductive Polyurethane Foams, Methods of Making the Same, and Articles Comprising the Same,” filed on Sep. 29, 2023, the disclosure of which is incorporated herein by reference in its entirety.

### FIELD

The present invention relates to polyurethane foam-forming compositions. In particular, the present invention relates to polyurethane foam-forming compositions suitable for forming polyurethane foams having excellent thermal conductivity, foams made from such compositions, methods of making such foams, and articles comprising such foams.

### BACKGROUND

Polyurethane foams are extensively used in a variety of industrial and consumer applications. The production of polyurethane foams is well known to those skilled in the art. Polyurethanes are produced from the reaction of —NCO isocyanate groups present in isocyanates with —OH hydroxyl groups present in polyols. The polyurethane foam production, the reaction of isocyanates with polyols, is carried out in the presence of several additives: surfactants, catalysts, cross-linking agents, flame retardants, water, blowing agents, and other additives.

Flexible polyurethane foams, a subcategory of the polyurethane foams, are generally soft, less dense, pliable, and subject to structural rebound subsequent to loading. Due to their high cushioning property, flexible polyurethane foams are widely used for vehicle cushion materials, furniture mats, beddings, miscellaneous goods, and the like. The flexible polyurethane foams are generally manufactured by reacting organic polyisocyanate with two or more compounds containing active hydrogen in the presence of a catalyst, a surfactant, and optionally other additives.

Polyurethane foams are generally efficient thermal insulators. In certain applications, however, it may be beneficial for the foam to be capable of dissipating heat. For example, it may be desirable for mattresses, pillows, toppers, cushions, and the like, to be able to dissipate heat. This may be to provide a cool feeling to the user or to prevent buildup of heat that may result in user discomfort. Alternatively, foams that cannot effectively dissipate heat may not be suitable for use in applications that produce heat such as in electronics or moving parts.

### SUMMARY

In one aspect, provided is a foam forming composition for forming a flexible polyurethane foam, where the foam composition comprises an additive for improving the thermal conductivity of the foam.

In one aspect, provided is a polyurethane foam-forming composition comprising: (a) a polyol; (b) a polyisocyanate; (c) a catalyst; (d) a surfactant; and (e) a thermally conductive filler. The thermally conductive filler comprises carbon rich carbon fibers.

In another aspect, provided is a thermally conductive foam formed from the foam-forming composition.

In still another aspect, provided is a method of making a foam from the foam-forming composition.

In yet another aspect, provided is an article comprising the thermally conductive foam.

In one aspect, provided is a flexible polyurethane foam comprising a thermally conductive filler, the thermally conductive filler selected from carbon rich carbon fibers.

In one embodiment, the foam comprises the thermally conductive filler in an amount of about 10 wt. % or less based on the total weight of the foam.

In one embodiment, the foam comprises the thermally conductive filler in an amount of from about 2 wt. % to about 10 wt. % based on the total weight of the foam.

In one embodiment in accordance with any of the previous embodiments, the thermally conductive filler has an effective fiber length of from about 0.6 mm to about 1.5 mm.

In one embodiment in accordance with any of the previous embodiments, the thermally conductive filler has a thermal conductivity of from about 100 W/m·K to about 4000 W/m. K.

In one embodiment in accordance with any of the previous embodiments, the thermally conductive filler has an aspect ratio of from about 15 to about 200.

In one embodiment in accordance with any of the previous embodiments, the thermally conductive filler has a density of from about 1.5 g/cm³ to about 3.5 g/cm³.

In one embodiment in accordance with any of the previous embodiments, the thermally conductive filler is derived from petroleum tar, a viscoelastic precursor that contains aromatic carbon rich materials, or mixtures thereof.

In one embodiment in accordance with any of the previous embodiments, the carbon rich carbon fibers comprise isotropic carbon fibers, mesophase carbon fibers, or mixtures thereof.

In one embodiment in accordance with any of the previous embodiments, the carbon rich carbon fibers are derived from carbon materials with a mixture of aromatic hydrocarbons comprising anisotropic liquid crystalline particles that, after being subjected to heat treatment, exhibit a graphitic structure wherein the carbon atoms are arranged in a hexagonal pattern that forms sheets that are aligned and stacked parallel to one another in a regular manner.

In one embodiment in accordance with any of the previous embodiments, the carbon rich fibers comprise linear fibers, branched fibers, or mixtures thereof. In one embodiment in accordance with any of the previous embodiments, a majority of the carbon rich fibers are linear.

In one embodiment in accordance with any of the previous embodiments, the polyurethane foam has a thermal conductivity of from about 0.04 W/mK to about 0.2 W/mK.

In one embodiment in accordance with any of the previous embodiments, the polyurethane foam has a density of from about 15 kg/m³ to about 150 kg/m³.

In another aspect, provided is a polyurethane foam-forming composition comprising: (a) a polyol; (b) a polyisocyanate; (c) a catalyst; (d) a surfactant; and (e) a thermally conductive filler selected from carbon rich carbon fibers.

In one embodiment, the thermally conductive filler is present in an amount of from about 1 to about 20 parts per hundred parts polyol (pphp). In one embodiment, the thermally conductive filler is present in an amount of from about 2.5 pphp to about 17.5 pphp. In one embodiment, the thermally conductive filler is present in an amount of from about 5 pphp to about 15 pphp. In one embodiment, the thermally conductive filler is present in an amount of from about 7.5 pphp to about 12 pphp

In one embodiment in accordance with any of the previous embodiments, the thermally conductive filler has a length of from about 2 mm to about 20 mm.

In one embodiment in accordance with any of the previous embodiments, the thermally conductive filler has an aspect ratio of from about 15 to about 200.

In one embodiment in accordance with any of the previous embodiments, the thermally conductive filler has a thermal conductivity of from about 100 W/m·K to about 4000 W/m· K.

In one embodiment in accordance with any of the previous embodiments, the thermally conductive filler has a density of from about 1.5 g/cm³ to about 3.5 g/cm³.

In still another aspect, provided is a polyurethane foam formed from the polyurethane foam-forming compositions of any of claims 10-15.

In method of forming a polyurethane foam comprising contacting a polyol and an isocyanate in the presence of a surfactant, a catalyst, and a thermally conductive filler selected from carbon rich carbon fibers.

In one embodiment, thermally conductive filler is present in an amount of from about 1 to about 20 parts per hundred parts polyol (pphp).

In one embodiment in accordance with any of the previous embodiments, the thermally conductive filler has a length of from about 2 mm to about 20 mm.

In one embodiment in accordance with any of the previous embodiments, the thermally conductive filler has an aspect ratio of from about 15 to about 200.

In one embodiment in accordance with any of the previous embodiments, the thermally conductive filler has a thermal conductivity of from about 100 W/m·K to about 4000 W/m·K.

In one embodiment in accordance with any of the previous embodiments, the thermally conductive filler has a density of from about 1.5 g/cm³ to about 3.5 g/cm³.

In one embodiment in accordance with any of the previous embodiments, the thermally conductive filler is dispersed in the polyol prior to contacting with the isocyanate.

In yet another aspect, provided is a polyurethane formed from the method in accordance with any of the previous embodiments.

In one embodiment, the foam comprises the thermally conductive filler in an amount of about 10 wt. % or less based on the total weight of the foam.

In one embodiment in accordance with any of the previous embodiments, the foam comprises the thermally conductive filler in an amount of from about 2 wt. % to about 10 wt. % based on the total weight of the foam.

In one embodiment in accordance with any of the previous embodiments, the thermally conductive filler has an effective fiber length of from about 0.6 mm to about 1 mm.

In one embodiment in accordance with any of the previous embodiments, the thermally conductive filler has a thermal conductivity of from about 100 W/m. K to about 4000 W/m· K.

In one embodiment in accordance with any of the previous embodiments, the thermally conductive filler has an aspect ratio of from about 15 to about 200.

In one embodiment in accordance with any of the previous embodiments, the thermally conductive filler has a density of from about 1.5 g/cm³ to about 3.5 g/cm³.

In one embodiment in accordance with any of the previous embodiments, the polyurethane foam has a thermal conductivity of from about 0.04 W/m. K to about 0.2 W/m·K.

In yet another aspect, provided is an article comprising the polyurethane foam of any of the previous embodiments.

In one embodiment, the article is selected from a mattress, a pillow, a mattress topper, a cushion, a pad, a seat, a damper for an electronic device, an insert for a tire, a battery, or a heat sink.

In still another aspect, provided is a thermal management material comprising the polyurethane foam of any of the previous embodiments.

The use of carbon rich carbon fibers has been found to provide a foam-composition that can yield a foam having excellent thermal conductive properties. The carbon rich carbon fibers have been found to be highly dispersible in the foam-forming composition and to have a benefit in the foam formed from such compositions. Further, that high thermal conductivity is generally preset over the life of the foam.

### BRIEF DESCRIPTION OF THE DRAWINGS

The accompanying drawings illustrate various systems, apparatuses, devices and related methods, in which like reference characters refer to like parts throughout, and in which:

FIG. 1 is a schematic representation of a polyurethane foam showing the cell structure and dispersion of thermally conductive fibers within the foam;

FIG. 2 is an optical image of a polyurethane foam in accordance with the technology;

FIG. 3 are optical images of a polyurethane foam in accordance with the technology; and

FIG. 4 are optical images of a polyurethane foam in accordance with the technology.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be appreciated that numerical values for a particular component or group of components can be combined to form new and non-specified ranges.

The present technology provides a thermally conductive foam. The foam can be formed from a thermally conductive foam-forming composition. The thermally conductive foam can be used in a variety of applications and finds particular use where heat dissipation in a foam or article is desirable.

The present technology provides a polyurethane foam-forming composition comprising: (a) a polyol; (b) a polyisocyanate; (c) a catalyst; (d) a surfactant; and (e) a thermally conductive filler, where the thermally conductive filler comprises carbon rich carbon fibers.

According to an embodiment, the polyurethane foam-forming composition is directed to preparation of flexible polyurethane foam. Flexible polyurethane foam is widely used for furniture cushions, mattresses, automotive cushions and padding, and numerous other applications requiring support and/or comfort. The present invention is useful in foams, which have densities as low as 15 kg/m³, and for the most part below about 150 kg/m³. In embodiments, the foam can have a density of from about 15 kg/m³ to about 150 kg/m³, from about 20 kg/m³ to about 100 kg/m³, from about 30 kg/m³ to about 90 kg/m³, or from about 40 kg/m³ to about 75 kg/m³.

The polyol (a) component can be any polyol useful to form a polyurethane foam and particularly for forming a flexible foam. The polyol is normally a liquid polymer possessing hydroxyl groups. The term “polyol” includes linear and branched polyethers (having ether linkages), polyesters and blends thereof, and comprising at least two hydroxyl groups. In one embodiment, the polyol can be at least one of the types generally used to prepare polyurethane foams. A polyether polyol having a weight average molecular weight of from about 150 to about 10,000 is particularly useful.

Polyols containing reactive hydrogen atoms generally employed in the production of flexible polyurethane foams can be employed in the foam-forming composition. The polyols are hydroxy-functional chemicals or polymers covering a wide range of compositions of varying molecular weights and hydroxy functionality. These polyhydroxyl compounds may be provided as a mixture of several components although pure polyhydroxyl compounds, i.e., individual compounds, can be used if desired.

Representative polyols include, but are not limited to, polyether polyols, polyester polyols, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, polycarbonate polyols, polyoxypropylene polyether polyol, mixed poly (oxyethylene/oxypropylene) polyether polyol, polybutadienediols, polyoxyalkylene diols, polyoxyalkylene triols, polytetramethylene glycols, polycaprolactone diols and triols, all of which possess at least two primary hydroxyl groups.

Examples of polyether polyols include, but are not limited to, polyoxyalkylene polyol, particularly linear and branched poly (oxyethylene)glycol, poly(oxypropylene)glycol, copolymers of the same and combinations thereof. Non-limiting examples of modified polyether polyols include polyoxypropylene polyether polyol into which is dispersed poly(styrene acrylonitrile) or polyurea, and poly (oxyethylene/oxypropylene) polyether polyols into which is dispersed poly(styrene acrylonitrile) or polyurea.

Examples of suitable polyols include, but are not limited to, those such as Arcol® polyol 1053, Arcol® E-743, Hyperlite® E-848 from Covestro, Voranol® CP3322 polyols from Dow, Lupranol poylols from BASF, Stepanpol® polyols from Stepan, Terate® polyols from Invista, or a combination of two or more thereof.

Graft or modified polyether polyols comprise dispersed polymeric solids.

Suitable polyesterpolyols include, but are not limited to, aromatic polyester polyols such as those made with pthallic anhydride (PA), dimethlyterapthalate (DMT) polyethyleneterapthalate (PET) and aliphatic polyesters, and the like.

Other non-limiting examples of suitable polyols include those derived from propylene oxide and ethylene oxide and an organic initiator or mixture of initiators of alkylene oxide polymerization and combinations thereof.

In one embodiment, the polyol can have a functionality of at least 2. In one embodiment, the polyol can have a functionality of from about 2 to about 12, from about 3 to about 10, from about 4 to about 8, or from about 5 to about 6.

The hydroxyl number of a polyol is the number of milligrams of potassium hydroxide required for the complete hydrolysis of the fully acylated derivative prepared from one gram of polyol. The hydroxyl number is also defined by the following equation, which reflects its relationship with the functionality and molecular weight of the polyol:

$$OH No . = ( 56.1 \times 1000 \times f ) / M . W .$$

wherein OH=hydroxyl number of the polyol; f=average functionality, that is, average number of hydroxyl groups per molecule of the polyether polyol; and M.W.=number average molecular weight of the polyether polyol. The average number of hydroxyl groups in the polyether polyol is achieved by control of the functionality of the initiator or mixture of initiators used in producing the polyether polyol.

In one embodiment, the polyurethane foam-forming composition comprises a polyether polyol having a hydroxyl number of from about 10 to about 3000, from about 20 to about 2000, from about 30 to about 1000 or from about 35 to about 800.

The polyisocyanate (b) can include any organic compound contain at least two isocyanate groups that can be used for production of polyurethane foam. In one embodiment, the polyisocyanate can be an organic compound that comprises at least two isocyanate groups and generally will be any known or later discovered aromatic or aliphatic polyisocyanates.

In one embodiment, the polyisocyanate can be a hydrocarbon diisocyanate, including alkylenediisocyanate and arylene diisocyanate.

Examples of suitable polyisocyanates include, but are not limited to, toluene diisocyanate, diphenylmethane isocyanate, polymeric versions of toluene diisocyanate and diphenylmethane isocyanate, methylene diphenyl diisocyanate (MDI), 2,4- and 2,6-toluene diisocyanate (TDI), triisocyanates and polymethylene poly(phenylene isocyanates) also known as polymeric or crude MDI, or combinations of two or more thereof. Commercially available 2,4- and 2,6-toluene diisocyanates include Mondur® TDI.

In one embodiment, the polyisocyanate can be at least one mixture of 2,4-toluene diisocyanate and 2,6-toluene diisocyanate wherein 2,4-toluene diisocyanate is present in an amount of from about 80 to about 85 weight percent of the mixture and wherein 2,6-toluene diisocyanate is present in an amount of from about 20 to about 15 weight percent of the mixture. It will be understood by a person skilled in the art that these ranges include all subranges there between.

The amount of polyisocyanate included in the polyurethane foam-forming composition relative to the amount of other materials in polyurethane foam-forming composition is described in terms of “Isocyanate Index.” “Isocyanate Index” means the actual amount of polyisocyanate used divided by the theoretically required stoichiometric amount of polyisocyanate required to react with all active hydrogen in polyurethane foam-forming composition multiplied by one hundred (100).

In one embodiment, the Isocyanate Index in the polyurethane foam-forming composition is from about 60 to about 300, from about 70 to about 200, or from about 80 to about 120.

The catalyst (c) for the production of the polyurethane foams herein can be a single catalyst or mixture of catalysts that can be used to catalyze the reactions of polyol and water with polyisocyanates to form polyurethane foam. It is common, but not required, to use both an organoamine and an organotin compound for this purpose. Other metal catalysts can be used in place of, or in addition to, organotin compound.

Representative and non-limiting examples of suitable materials for the catalyst (c) include, but are not limited to:
(i) tertiary amines such as bis(2,2′-dimethylamino)ethyl ether, trimethylamine, triethylenediamine, 1,8-diazabicyclo [5.4.0]undec-7-ene, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, 2-{[2-(2-dimethylaminoethoxy)ethyl]methylamino}ethanol, pyridine oxide, and the like;
(ii) strong bases such as alkali and alkaline earth metal hydroxides, alkoxides, phenoxides, and the like;
(iii) acidic metal salts of strong acids such as ferric chloride, stannous chloride, antimony trichloride, bismuth nitrate and chloride, and the like;
(iv) chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with various metals such as Be, Mg, Zn, Cd, Pb, Ti, Zr, Sn, As, Bi, Cr, Mo, Mn, Fe, Co, Ni, or such ions as MoO₂⁺⁺, UO₂⁺⁺, and the like;
(v) alcoholates and phenolates of various metals such as Ti(OR)₄, Sn(OR)₄, Sn(OR)₂, Al(OR)₃, and the like, wherein R is alkyl or aryl of from 1 to about 12 carbon atoms, and reaction products of alcoholates with carboxylic acids, beta-diketones, and 2-(N,N-dialkylamino) alkanols, such as chelates of titanium obtained by this or equivalent procedures;
(vi) salts of organic acids with a variety of metals such as alkali metals, alkaline earth metals, Al, Sn, Pb, Mn, Co, Bi, and Cu, including, for example, sodium acetate, potassium laurate, calcium hexanoate, stannous acetate, stannous octoate, stannous oleate, lead octoate, metallic driers such as manganese and cobalt naphthenate, and the like;
(vii) organometallic derivatives of tetravalent tin, trivalent and pentavalent As, Sb, and Bi, and metal carbonyls of iron and cobalt;
or combinations of two or more thereof.

In one embodiment, the catalyst (c) is selected from organotin compounds that are dialkyltin salts of carboxylic acids, including the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations of two or more thereof.

Still other examples of suitable catalysts that may be used include, but are not limited to, trialkyltin hydroxide, dialkyltin oxide, dialkyltin dialkoxide, or dialkyltin dichloride, and combinations of two or more thereof can be employed. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide) dibutyltin-bis(2-dimethylaminopentylate), dibutyltin dichloride, dioctyltin dichloride, and the like, and combinations of two or more thereof.

In one embodiment, the catalyst can be an organotin catalyst such as stannous octoate, dibutyltin dilaurate, dibutyltin diacetate, stannous oleate, or combinations of two or more thereof. In another embodiment, the catalyst can be an organoamine catalyst, for example, tertiary amine such as trimethylamine, triethylamine, triethylenediamine, bis(2,2-dimethylamino)ethyl ether, N-cthylmorpholine, diethylenetriamine, 1,8-diazabicyclo [5.4.0]undec-7-ene, or combinations of two or more thereof. In still another embodiment, the catalyst can include mixtures of tertiary amine and glycol, such as Niax® catalyst C-183 (Momentive Performance Materials Inc.), stannous octoate, such as Niax® stannous octoate catalysts (Momentive Performance Materials Inc.), or combinations of two or more thereof.

The surfactant (d) may be as selected as desired for a particular purpose or intended application. Any suitable surfactant that is used in polyurethane foam production may be used. The amount of surfactant may be in the range of about 0.01 wt. % to about 4 wt. %. In on embodiment, the surfactant may be used in the range of about 0 wt. % to about 3 wt. %, or from about 0 wt. % to about 2 wt. %. In one embodiment, the surfactant is present in an amount of from about 0.01 wt. % to about 4 wt. %, from about 0.05 wt. % to about 3 wt. %, from about 0.1 wt. % to about 2.5 wt. %, or from about 0.5 wt. % to about 1 wt. %.

Examples of suitable surfactants include, but are not limited to, TEGOSTAB® BF-2370, BF-2470 from Evonik; and/or NIAX™ L-895, NIAX™ L-894 NIAX™ L-818, NIAX™ L-820; NIAX™ L-580, NIAX™ L-620 from Momentive Performance Materials Inc., but the surfactant is not limited to these examples. Particularly suitable surfactants are silicone surfactants such as those sold under the tradename NIAX from Momentive Performance Materials Inc.

The polyurethane foam-forming compositions includes a thermally conductive filler (c). The thermally conductive filler is selected from carbon rich carbon fibers. The carbon rich carbon fibers may be derived from, for example, petroleum tar or a viscoelastic precursor that contains aromatic carbon rich materials. The carbon rich carbon fibers may be isotropic or mesophase. Carbon rich carbon fibers may be derived from carbon materials with a complex mixture of numerous essentially aromatic hydrocarbons containing anisotropic liquid crystalline particles that, after being subjected to heat treatment, exhibit a graphitic structure wherein the carbon atoms are arranged in a hexagonal pattern that forms sheets that are aligned and stacked parallel to one another in a regular manner. The fibers may be linear or branched. In embodiments, a majority of the fibers are linear.

The carbon fibers added to the foam-forming composition may have a length of from about 2 mm to about 20 mm, from about 3 mm to about 18 mm, from about 5 mm to about 15 mm, or from about 7.5 mm to about 10 mm. In embodiments, the carbon fibers added to the foam-forming composition have a length of from about 2 mm to about 8 mm or from about 3 mm to about 5 mm. For branched fibers, the length of the fiber is determined by the longest segment of the fiber.

The carbon fibers may have a diameter of from about 5 μm to about 10 μm, from about 6 μm to about 9 μm, or from about 7 μm to about 8 μm.

The carbon fibers may have an aspect ratio (L/D) of from about 15 to about 200, from about 30 to about 175, from about 45 to about 150, from about 50 to about 125, or from about 75 to about 100.

The carbon fibers may have a thermal conductivity of from about 100 W/m·K to about 4000 W/m·K, from about 250 W/m·K to about 3000 W/m·K, from about 500 W/m·K to about 2500 W/m·K, or from about 1500 W/m. K to about 2000 W/m·K.

The carbon fibers are present in the foam-forming composition in an amount of from about 1 to about 20 parts per hundred parts polyol (pphp), from about 2.5 pphp to about 17.5 pphp, from about 5 pphp to about 15 pphp, or from about 7.5 pphp to about 12 pphp.

The polyurethane foam-forming composition can include other components (f), such as a blowing agent. The blowing agent can be one blowing agent of the physical and/or chemical type. Typical physical blowing agents include, but are not limited to methylene chloride, acetone, water or CO2, which are used to provide expansion in the foaming process. A typical chemical blowing agent is water, which reacts with isocyanates in the foam, forming reaction mixture to produce carbon dioxide gas. These blowing agents possess varying levels of solubility or compatibility with the other components used in the formation of polyurethane foams. Developing and maintaining a good emulsification when using components with poor compatibility is critical to processing and achieving acceptable polyurethane foam quality.

In one embodiment, the composition comprises water in an amount of from about 0.5 to about 5 parts by weight (pbw), from about 1 to about 4 pbw, from about 1.5 to about 3.5 pbw, or from about 2 to about 3 pbw.

Other components (g), such as additives, can be added to polyurethane foam to impart specific properties to polyurethane foam. Examples of other suitable additives include, but not limited to, fire retardant, stabilizer, coloring agent, filler, anti-bacterial agent, extender oil, anti-static agent, solvent and combinations thereof.

Methods for producing polyurethane foam from the polyurethane foam-forming composition of the present invention are not particularly limited. Various methods commonly used in the art may be employed. For example, various methods described in “Polyurethane Resin Handbook,” by Keiji Iwata, Nikkan Kogyo Shinbun, Ltd., 1987 may be used. For example, the composition of the present invention can be prepared by combining the polyols, catalyst, surfactants, blowing agent, thermally conductive agent, and additional compounds including optional ingredients into a premix. The following procedure was used in the lab for preparing the polyether foam: polyols, amine catalysts, water and silicones were mixed for 60 seconds. Stannous Octoate was added and mixing continued for 10 seconds. After that TDI was added and the mixing continued for 5 seconds. Once the mixing process was finished, the liquid foam was poured into a 20×20×20 cm paper box. The foam rise profile was recorded, and the foams were cured in a forced air oven for 15 minutes then cooled for 24 hours.

In embodiments, the carbon fibers are added the polyol prior to mixing with the other components for forming the foam. The carbon fibers are dispersed in the polyol by mixing the fibers in the polyol. Mixing can be carried out for any suitable time or mixing speed to effectively disperse the carbon fibers in the polyol. In embodiments, the carbon fibers can be dispersed in the polyol by mixing at from about 1200 to about 1600 rpm for 30 seconds to 2 minutes.

The polyol/carbon fiber composition can then be contacted with the other components for the polyurethane foam-forming composition and mixed and processed to form the foam.

The mixing process of dispersing the carbon fibers in the polyol and subsequent mixing of the polyol/carbon fiber mixture with the other components has the effect of breaking up the carbon fibers so as to reduce their size. As such, in the final foam-forming composition prior to formation of the foam, and in the final foam, the carbon fibers have an effective length of from about 0.1 mm to about 1.5 mm, 0.3 mm to about 1 mm, or from about 0.5 mm to about 0.8 mm. In one embodiment, the carbon fibers have an effective length of from about 0.6 mm to about 1 mm. Applicant has found that the starting carbon fiber lengths (of from about 2 to about 20 mm) are suitable for providing good dispersity of the carbon fibers within the foam-forming composition, that will yield fibers with an effective length to provide good thermal conductivity.

The foams formed from the compositions may have a density of from about 15 kg/m³ to about 100 kg/m³, from about 25 kg/m³ to about 75 kg/m³, or from about 35 kg/m³ to about 45 kg/m³.

In the final foam, the carbon fibers are present in an amount of from about 2 wt. % to about 10 wt. %, from about 4 wt. % to about 8 wt. % or from about 5 wt. % to about 7 wt. % based on the total weight of the foam.

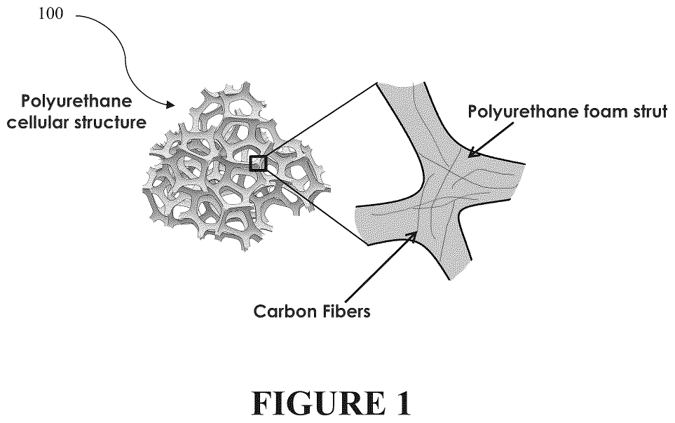

The carbon fibers are dispersed throughout the foam matrix. FIG. 1 illustrates a polyurethane foam structure 100. The close up shows a plurality of carbon fibers disposed within the struts of the foam. Carbon fibers may overlap with one another and contact one another. The contact points between two or more fibers creates a network that provides a path for thermal conduction.

The density of the thermally conductive filler within the final foam product may be from about 1.5 g/cm³ to about 3.5 g/cm³, from about 2 5 g/cm³ to about 3 5 g/cm³, or from about 2.25 g/cm³ to about 2.5 g/cm³.

The foams formed from the foam-forming composition may have a thermal conductivity of from about 0.04 W/m·K to about 0.2 W/m·K, from about 0.08 W/m·K to about 0.18 W/m·K, from about 0.1 W/m·K to about 0.16 W/m· K, or from about 0.12 W/m·K to about 0.15 W/m·K.

A foam in accordance with the present technology can be used in a variety of applications including any application where a foam material may be desirable or useful. A foam in accordance with the present technology is particularly suitable for use as or part of a thermal management material or article. In one embodiment, a foam in accordance with the present technology may be suitable for use in, but not limited to, a mattress, pillow, cushion, mattress topper, quilted topper, body support, a pad, a seat, a damper for an electronic device, an insert for a tire, a battery, or a heat sink, and the like. In such applications, a cooler feeling foam may be desirable, and a foam in accordance with the present technology provides for such a feel as they are suitable for conducting heat (through the open air cells and natural convection to remove the heat from the system). A foam in accordance with the present technology can be employed to form the entirety or a portion (e.g., a layer or section) of the article.

### Examples

Polyurethane foams were prepared according to the formulas as indicated in the following tables. A mixture of polyol and thermally conductive carbon fibers was prepared. The polyol/carbon fiber mixture was then mixed with the remaining components, and a foam was formed as follows. The carbon rich carbon fibers and the polyol are mixed for about 1 to 2 minutes at about 1000 to about 1500 RPM. The silicone surfactant, catalyst, and water are then added and mixed for about 30 seconds to about 1 minute. The tin catalyst is added and mixed followed by addition of the diisocyanate. The composition is mixed for about five seconds, and then poured into a box container. CE-1, CE-2, and CE-3 are comparative examples that do not include carbon rich carbon fibers as a thermally conductive filler.

TABLE 1

| Material | CE-1 | Ex. 1 | Ex. 2 | CE-2 | Ex. 3 | Ex. 4 | CE-3 | Ex. 5 | Ex. 6 |
|---|---|---|---|---|---|---|---|---|---|
| Polyol | 100 | 100 | 100 | 100 | 100 | 100 | 100 | 100 | 100 |
| TDI (index | 57.4 | 57.4 | 57.4 | | | | | | |
| 110) | | | | | | | | | |
| MDI | | | | 53.66 | 53.66 | 53.66 | 40.8 | 40.8 | 40.8 |
| (index 78) | | | | | | | | | |
| Water | 4.5 | 4.5 | 4.5 | 2.64 | 2.64 | 2.64 | 1.5 | 1.5 | 1.5 |
| Thermally | 0 | 5 | 10 | 0 | 5 | 10 | 0 | 5 | 10 |
| Conductive | | | | | | | | | |
| Filler | | | | | | | | | |
| EF-100 | | | | | | | 0.1 | 0.1 | 0.1 |
| EF-700 | | | | | | | 0.3 | 0.3 | 0.3 |
| Amine | 0.12 | 0.12 | 0.12 | | | | | | |
| Catalyst | | | | | | | | | |
| Tin | 0.18 | 0.18 | 0.18 | 0.14 | 0.14 | 0.14 | | | |
| Catalyst | | | | | | | | | |
| Niax L-894 | 1 | 1 | 1 | | | | | | |
| Niax L-818 | | | | 0.7 | 0.7 | 0.7 | 0.7 | 0.7 | 0.7 |
| Density | 24 | 24 | 24 | 45 | 45 | 45 | 75 | 75 | 75 |
| (kg/m3) | | | | | | | | | |
| Thermal | 0.04009 | 0.05198 | 0.05922 | 0.04211 | 0.07088 | 0.09169 | 0.04872 | 0.1133 | 0.1507 |
| Conductivity | | | | | | | | | |
| (W/mK) | | | | | | | | | |

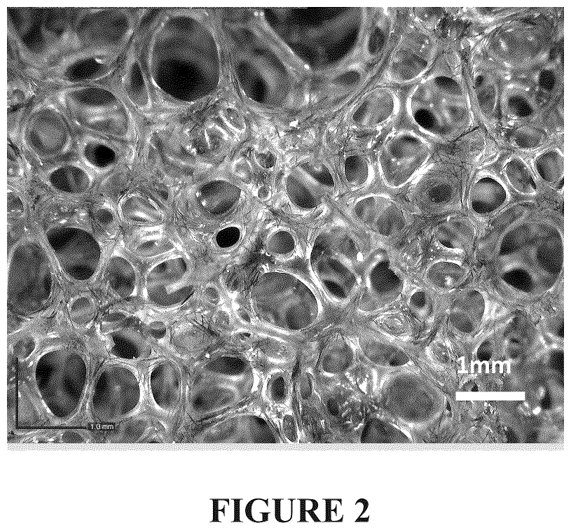

FIG. 2 is an optical image of the polyurethane foam of example Ex. 6.

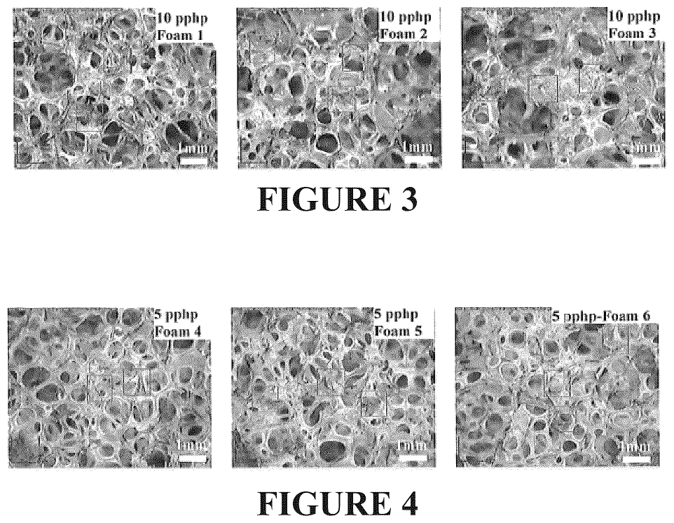

FIGS. 3 and 4 are optical images of the foams of Examples 5 and 6 taken to evaluate the dispersion or density of the fibers within the polyurethane foam. Optical images of the foams of Examples 5 and 6 were taken at three different quadrants covering a 1 mm² area. The number of fibers in each image were counted with the assistance of ImageJ software. FIG. 3 is a series of optical images of the foam of example 6 (10 pphp of fiber), which showed a fiber density of 42+/−3 fibers/mm². FIG. 4 is a series of optical images of the foam of example 5 (5 pphp of fiber), which showed a fiber density of 32+/−4 fibers/mm². The low standard of deviation demonstrates good dispersion of the fibers throughout the material.

### Comparison of Foams Employing Other Thermally Conductive Fillers

Foam compositions were prepared employing thermally conductive fillers other than carbon fibers in accordance with the present technology. Foams with a density of 45 kg/m³ were prepared as follows. The foams in Table 2 have a base foam formulation based on example CE-2, but, with the exception of CE-4, include the fillers indicated in the table. Thermally conductive fillers such as boron nitride, calcium carbonate, graphite powders, graphite flakes, aluminum oxide, and polyacrylonitrile (PAN) carbon fibers were added to the compositions in the amounts listed in Table 2. Table 2 also shows the thermal conductivity of the compositions.

TABLE 2
Conductivity

| | | Filler | Thermal |
|---|---|---|---|
| | | concentration | Conductivity |
| Example | Filler | (pphp) | (W/mK) |
| CE-4 | None | — | 0.04211 |
| CE-5 | Boron Nitride | 20 | 0.04662 |
| | (BN) PT 132 | | |
| CE-6 | BN PT 110 | 20 | 0.05139 |
| CE-7 | BN PT110 | 40 | 0.05479 |
| CE-8 | BNHCV | 20 | 0.05179 |
| CE-9 | BN PT 396 | 20 | 0.05456 |
| CE-10 | BN PT350 | 20 | 0.05171 |
| CE-11 | BN PT 140 | 20 | 0.05519 |
| CE-12 | CaCO₃ calcium | 20 | 0.04556 |
| | carbonate | | |
| CE-13 | Graphite Powder | 20 | 0.04697 |
| CE-14 | Graphite Flakes | 20 | 0.04938 |
| CE-15 | Al₂O₃ 45 μm | 20 | 0.04450 |
| | Aluminum oxide | | |
| CE-16 | Al₂O₃ 200 μm | 20 | 0.04442 |
| | Aluminum oxide | | |
| CE-17 | PAN carbon | 20 | 0.05090 |
| | fibers 150 μm | | |
| CE-18 | PAN carbon | 5 | 0.05522 |
| | fibers 6 mm | | |

Foams with a density of 75 kg/m³ were also made with a formulation based on the base foam formulation of CE-3 that employ carbon rich carbon fibers in accordance with the present technology. Two foams use fibers of 0.150 mm at 5 or 10 pphp, or fibers of 0.250 mm at 10 pphp. CE-19 is provided as a comparison without any thermally conductive filler. Table 3 shows those results.

TABLE 3

| | | Filler | Thermal |
|---|---|---|---|
| | | concentration | Conductivity |
| Example | Filler | (pphp) | (W/mK) |
| CE-19 | None | — | 0.04872 |
| Ex. 7 | Carbon Fibers | 5 | 0.06743 |
| | 0.150 mm | | |
| Ex. 8 | Carbon Fibers | 10 | 0.08805 |
| | 0.150 mm | | |
| Ex. 9 | Carbon Fibers | 10 | 0.08582 |
| | 0.250 mm | | |

The foregoing description identifies various, non-limiting embodiments of polyurethane foam-forming compositions comprising polyether functional siloxanes, and foams made therefrom in accordance with aspects of the present invention. Modifications may occur to those skilled in the art and to those who may make and use the invention. The disclosed embodiments are merely for illustrative purposes and not intended to limit the scope of the invention or the subject matter set forth in the following claims.

What is claimed is:

1. A flexible polyurethane foam comprising a thermally conductive filler, the thermally conductive filler selected from carbon rich carbon fibers.

2. The flexible polyurethane foam of claim 1 comprising the thermally conductive filler in an amount of about 10 wt. % or less based on the total weight of the foam.

3. The flexible polyurethane foam of claim 1 comprising the thermally conductive filler in an amount of from about 2 wt. % to about 10 wt. % based on the total weight of the foam.

4. The flexible polyurethane foam of claim 1, wherein the thermally conductive filler has an effective fiber length of from about 0.6 mm to about 1.5 mm.

5. The flexible polyurethane foam of claim 1, wherein the thermally conductive filler has a thermal conductivity of from about 100 W/m·K to about 4000 W/m·K.

6. The flexible polyurethane foam of claim 1, wherein the thermally conductive filler has an aspect ratio of from about 15 to about 200.

7. The flexible polyurethane foam of claim 1, wherein the thermally conductive filler has a density of from about 1.5 g/cm³ to about 3.5 g/cm³.

8. The flexible polyurethane foam of claim 1, wherein the polyurethane foam has a thermal conductivity of from about 0.04 W/mK to about 0.2 W/mK.

9. The flexible polyurethane foam of claim 1, wherein the polyurethane foam has a density of from about 15 kg/m³ to about 150 kg/m³.

10. A polyurethane foam-forming composition comprising:
(a) a polyol;
(b) a polyisocyanate;
(c) a catalyst;
(d) a surfactant; and
(e) a thermally conductive filler selected from carbon rich carbon fibers.

11. The polyurethane foam-forming composition of claim 10, wherein the thermally conductive filler is present in an amount of from about 1 to about 20 parts per hundred parts polyol (pphp).

12. The polyurethane foam-forming composition of claim 10, wherein the thermally conductive filler has a length of from about 2 mm to about 20 mm.

13. The polyurethane foam-forming composition of claim 10, wherein the thermally conductive filler has an aspect ratio of from about 15 to about 200.

14. The polyurethane foam-forming composition of claim 10, wherein the thermally conductive filler has a thermal conductivity of from about 100 W/m·K to about 4000 W/m·K.

15. The polyurethane foam-forming composition of claim 10, wherein the thermally conductive filler has a density of from about 1.5 g/cm³ to about 3.5 g/cm³.

16. A polyurethane foam formed from the polyurethane foam-forming compositions of claim 10.

17. A method of forming a polyurethane foam comprising contacting a polyol and an isocyanate in the presence of a surfactant, a catalyst, and a thermally conductive filler selected from carbon rich carbon fibers.

18. The method of claim 17, wherein the thermally conductive filler is present in an amount of from about 1 to about 20 parts per hundred parts polyol (pphp).

19. The method of claim 17, wherein the thermally conductive filler has a length of from about 2 mm to about 20 mm.

20. The method of claim 17, wherein the thermally conductive filler has an aspect ratio of from about 15 to about 200.

21. The method of claim 17, wherein the thermally conductive filler has a thermal conductivity of from about 100 W/m·K to about 4000 W/m·K.

22. The method of claim 17, wherein the thermally conductive filler has a density of from about 1.5 g/cm³ to about 3.5 g/cm³.

23. The method of claim 17, wherein the thermally conductive filler is dispersed in the polyol prior to contacting with the isocyanate.

24. A polyurethane formed from the method of claim 17.

25. The polyurethane foam of claim 24, comprising the thermally conductive filler in an amount of about 10 wt. % or less based on the total weight of the foam.

26. The polyurethane foam of claim 24 comprising the thermally conductive filler in an amount of from about 2 wt. % to about 10 wt. % based on the total weight of the foam.

27. The polyurethane foam of claim 24, wherein the thermally conductive filler has an effective fiber length of from about 0.6 mm to about 1 mm.

28. The polyurethane foam of claim 24, wherein the thermally conductive filler has a thermal conductivity of from about 100 W/m·K to about 4000 W/m·K.

29. The polyurethane foam of claim 24, wherein the thermally conductive filler has an aspect ratio of from about 15 to about 200.

30. The polyurethane foam of claim 24, wherein the thermally conductive filler has a density of from about 1.5 g/cm³ to about 3.5 g/cm³.

31. The polyurethane foam of claim 24, wherein the polyurethane foam has a thermal conductivity of from about 0.04 W/m·K to about 0.2 W/m·K.

32. An article comprising the polyurethane foam of claim 1.

33. The article of claim 32, wherein the article is selected from a mattress, a pillow, a mattress topper, a cushion, a pad, a seat, a damper for an electronic device, an insert for a tire, a battery, or a heat sink.

34. A thermal management material comprising the polyurethane foam of claim 1.

35. A thermal management material comprising the polyurethane foam of claim 16.

36. A thermal management material comprising the polyurethane foam of claim 23.
